(19) United States
(12) Patent Application Publication
(10) Pub. No.: US 2023/0108422 A1
(43) Pub. Date: Apr. 6, 2023

(54) METHODS AND SYSTEMS FOR USE IN PROCESSING IMAGES RELATED TO CROPS

(71) Applicant: MONSANTO TECHNOLOGY LLC, Saint Louis, MO (US)

(72) Inventors: Robert BRAUER, Lincoln, NE (US); Bhaskar DUTTA, Cottleville, MO (US); Mohammad Alfi HASAN, Saint Louis, MO (US); Kyle PARMLEY, Ankeny, IA (US)

(21) Appl. No.: 17/956,119

(22) Filed: Sep. 29, 2022

Related U.S. Application Data
(60) Provisional application No. 63/250,345, filed on Sep. 30, 2021.

(51) Int. Cl. A01B 79/00; G06T 7/00; G06T 3/40; G06V 20/10; G06V 20/13; G06V 10/62; G06V 10/82; G06N 3/04

(52) U.S. Cl. CPC A01B 79/005; G06T 7/0016; G06T 3/4092; G06V 20/188; G06V 20/13; G06V 10/62; G06V 10/82; G06N 3/049; G06T 2207/10036; G06T 2207/20081; G06T 2207/20084; G06T 2207/30188

(57) ABSTRACT

Systems and methods are provided for use in processing image data associated with crop-bearing fields. One example computer-implemented method includes accessing a first data set including images associated with a field, where the images have a spatial resolution of about one pixel per at least about one meter, and generating, based on a generative model, defined resolution images of the field from the first data set. In doing so, the defined resolution images each have a spatial resolution of about X centimeters per pixel, where X is less than about 5 centimeters. The method also includes deriving index values for the field, based on the defined resolution images of the field, and predicting a characteristic (e.g., a yield, etc.) for the field based on the index values and, in some implementations, at least one environmental metric for the field.

### CROSS-REFERENCE TO RELATED APPLICATION

This application claims the benefit of, and priority to, U.S. Provisional Application No. 63/250,345, filed on Sep. 30, 2021. The entire disclosure of the above application is incorporated herein by reference.

### FIELD

The present disclosure generally relates to methods and systems for use in processing images related to crops and phenotypic expressions associated therewith and, in particular, to methods and systems for use in enhancing spatial resolution of images and forecasting crop characteristics based on the enhanced images.

### BACKGROUND

This section provides background information related to the present disclosure which is not necessarily prior art.

Images of fields are known to be captured in various manners, including, for example, by satellites, unmanned and manned aerial vehicles, etc. The images are known to have different characteristics based on the manner in which the images are captured. Satellite images, for example, may include resolutions of 30 meters by 30 meters per pixel, while images captured by aerial vehicles may have a resolutions of less than one inch by one inch per pixel, etc.

The images of the fields, once captured, are further known to be processed (e.g., analyzed, etc.), and then used to determine growth stages, for example, of crops planted in the fields represented by the images.

### SUMMARY

This section provides a general summary of the disclosure, and is not a comprehensive disclosure of its full scope or all of its features.

Example embodiments of the present disclosure generally relate to computer-implemented methods for use in processing image data associated with crop-bearing field. In one example embodiment, such a method generally includes accessing, by a computing device, a first data set, the first data set including images associated with one or more fields, the images having a spatial resolution of about one meter or more per pixel; generating, by the computing device, based on a generative model, defined resolution images of the one or more fields from the first data set, the defined resolution images each having a spatial resolution of about X centimeters per pixel, where X is less than about 5 centimeters; deriving, by the computing device, index values for the one or more fields, based on the defined resolution images of the one or more fields; aggregating, by the computing device, the index values for the one or more fields with at least one environmental metric for the one or more fields; predicting, by the computing device, a plot yield for the one or more fields, based on the aggregated index values and the at least one environmental metric; and storing, by the computing device, the predicted yield for the one or more fields in a memory.

Example embodiments of the present disclosure also generally relate to systems for use in processing image data associated with crop-bearing fields. In one example embodiment, such a system generally includes a computing device configured to: access a first data set, the first data set including images associated with one or more fields, the images having a spatial resolution of about one meter or more per pixel; generate, based on a generative model, defined resolution images of the one or more fields from the first data set, the defined resolution images each having a spatial resolution of about X centimeters per pixel, where X is less than about 5 centimeters; derive index values for the one or more fields, based on the defined resolution images of the one or more fields; aggregate the index values for the one or more fields with at least one environmental metric for the one or more fields; predict a plot yield for the one or more fields, based on the aggregated index values and the at least one environmental metric; and store the predicted yield for the one or more fields in a memory.

Example embodiments of the present disclosure also generally relate to computer-readable storage media including executable instructions for processing image data. In one example embodiment, a computer-readable storage medium includes executable instructions, which when executed by at least one processor, cause the at least one processor to: access a first data set of images having a spatial resolution of about one meter or more per pixel; generate, based on a generative model, defined resolution images of the one or more fields from the first data set of images, the defined resolution images each having a spatial resolution of about X centimeters per pixel, where X is less than about 5 centimeters; derive index values for a feature of the images included in the first data set of images, based on the corresponding defined resolution images; aggregate the index values for the feature with at least one metric for the feature; predict a characteristic for the feature, based on the aggregated index values and the at least one environmental metric; and store the predicted characteristic for the feature in a memory.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments, are not all possible implementations, and are not intended to limit the scope of the present disclosure.

FIG. 1 illustrates an example system of the present disclosure configured for enhancing spatial resolution of images of crops, fields, etc., and forecasting crop characteristics based on the enhanced images;

FIG. 2A is a block diagram of an example architecture of an image engine that may be used in the system of FIG. 1;

FIG. 2B is a block diagram of another example architecture that may be used in the system of FIG. 1;

FIG. 3 is a block diagram of an example computing device that may be used in the system of FIG. 1;

FIG. 4 illustrates a flow diagram of an example method, suitable for use with the system of FIG. 1, for forecasting one or more characteristics of crops based on enhanced images of fields in which the crops are grown;

FIGS. 5A-5B illustrate example images that may be associated with the system of FIG. 1 and/or the method of FIG. 4, including start images having relatively lower spatial resolutions and generated defined resolution images having relatively higher spatial resolutions; and

FIG. 6 illustrates additional example images that may be associated with the system of FIG. 1 and/or the method of FIG. 4, including start images having relatively lower spatial resolutions and generated defined resolution images having relatively higher spatial resolutions.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Images may be used to identify, and obtain insights into, different crop characteristics within fields in which the crops are planted/growing. However, spatial resolution and availability (e.g., over certain intervals, etc.) (i.e., temporal resolution) of the images may impact the ability of different techniques to accurately forecast the insights and/or characteristics. For example, satellite images may provide desired temporal density, but may lack spatial resolution, while unmanned aerial vehicle (UAV) and/or manned aerial vehicle (MAV) images may include desired spatial resolution, but may be temporally sparse. Absence of images with sufficient temporal and spatial resolution therefore hinders the different techniques from accurately forecasting crop characteristics, based on such imagery.

Uniquely, the systems and methods herein enable resolutions of certain images to be enhanced, whereby, for example, certain imagery of fields (having relatively higher temporal resolution) (e.g., satellite imagery, etc.) may gain sufficient spatial resolution to provide precise and accurate forecasting of crop characteristics. That said, while the following description is provided with regard to images of crops in fields, it should be appreciated that the description may also be applied to other images of any suitable subject (e.g., images of subjects other than crops, images of subjects other than fields, etc.) within the scope of the present disclosure.

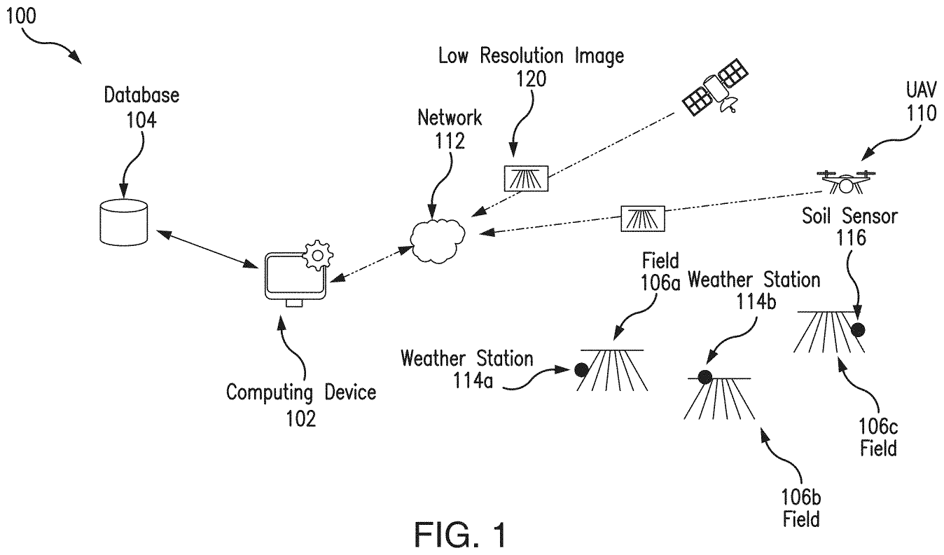

FIG. 1 illustrates an example system 100 in which one or more aspects of the present disclosure may be implemented. Although the system 100 is presented in one arrangement, other embodiments may include the parts of the system 100 (or additional parts) arranged otherwise depending on, for example, the types of images available, the manner in which the images are obtained, the types of crops included in the images, the number of fields present/available, etc.

As shown, the system 100 generally includes a computing device 102, and a database 104 coupled to (and in communication with) the computing device 102, as indicated by the arrowed line. The computing device 102 and database 104 are illustrated as separate in the embodiment of FIG. 1, but it should be appreciated that the database 104 may be included, in whole or in part, in the computing device 102 in other system embodiments. The computing device 102 is also coupled to (and in communication with) network 112. The network 112 may include, without limitation, a wired and/or wireless network, a local area network (LAN), a wide area network (WAN) (e.g., the Internet, etc.), a mobile network, and/or another suitable public and/or private network capable of supporting communication among two or more of the illustrated parts of the system 100, or any combination thereof.

That said, in general, the computing device 102 is configured to initially access a data set (or multiple data sets) including images of one or more fields (broadly, images of a subject or a feature) from the database 104 (e.g., where the images are collected as generally described herein, for example, from satellites, from other aerial vehicles, etc.). The computing device 102 is configured to then generate defined resolution images of the one or more fields from the data set (specifically, from the images included in the data stet) (e.g., per image included in the accessed data set, etc.), and derive one or more index values from the defined resolution images. The computing device 102 is configured to then predict at least one characteristic of a crop (or multiple crops) included in the one or more fields (broadly, predict at least one characteristic of a subject or a feature of the images), based on the one or more index values.

In connection with the above, the system 100 includes multiple fields 106a-c. The fields 106a-c, in general, are provided for planting, growing and harvesting crops, etc., in connection with farming, for example. While only three fields 106a-c are shown in FIG. 1, it should be appreciated that another number of fields may be included in other embodiments, including, for example, dozens, hundreds or thousands of fields, covering several acres (e.g., at least 1 or more acre, 10 or more acres, 50 or more acres, 100 or more acres, 200 or more acres, etc.). It should also be understood that the fields 106a-c may be understood to include (or to more generally refer to) growing spaces for crops, and which are exposed for satellite and aerial imaging regardless of size, etc. Further, it should be appreciated that the fields 106a-c may be viewed as including or representing or defining one or more plots (e.g., geographically, etc.), where the plot(s) may include a portion of one or more of the fields 106a-c, an entire one of the fields 106a-c, multiple ones of the fields 106a-c together, etc. The plot(s) may be any suitable size(s) (e.g., with dimensions ranging from about two meters to about 30 meters or more, etc.). Moreover, the size(s) of the plot(s) may be specific to crops, tests, experiments, regions, etc. associated therewith. Often, the fields 106a-c may each include multiple plots. For example, the field 106a may include three different corn hybrids, where the area in which each hybrid is planted defines a different plot within the field 106a.

In this example embodiment, each of the fields 106a-c may be populated with one or more crops as desired by a grower or farmer associated with the given one (or more) of the fields 106 a-c. The different crops (or plants) in the fields 106 a-c may include, for example (and without limitation), corn (or maize), wheat, beans (e.g., soybeans, etc.), peppers, tomatoes, tobacco, eggplant, corn or maize, rice, rye, sorghum, sunflower, potatoes, cotton, sweet potato, coffee, coconut, pineapple, citrus trees, prunes, cocoa, banana, avocado, fig, guava, mango, olive, papaya, cashew, almond, sugar beets, sugarcane, oats, barley, vegetables, or other suitable crops or products or combinations thereof, etc. In addition, the fields 106a-c may each include the same type of plants/crops, or a number of different varieties of the same type of plants (or crops), or different crops all together planted therein. For example, field 106a may include a first hybrid maize plant, while field 106c may include a second, different hybrid maize plant. Alternatively, the field 106a may include a third, different hybrid maize plant, while the field 106b may include a first hybrid soybean plant, etc. It should also be appreciated that the fields 106a-c (and other fields) may be located in proximity to one another, or not. That said, reference to a field herein should not be understood as a geographic limitation to the present disclosure, as reference to a plot or to a growing space may instead be used without departing from the description herein.

Further, the system 100 includes multiple image capture devices, including, in this example embodiment, a satellite 108 and an unmanned aerial vehicle (UAV) 110. In connection therewith, an image captured by (or from) the satellite 108, having spatial and temporal resolutions as described herein, may be referred to as a sat_image. And, an image captured by (or from) the UAV 110, having spatial and temporal resolutions as described herein, may be referred to as a UAV_image. While only one satellite 108 and one UAV 110 are illustrated in FIG. 1, for purposes of simplicity, it should be appreciated that system 100 may include multiple satellites and/or multiple UAVs. What's more, the same and/or alternate image capture devices (e.g., including a manned aerial vehicle (MAV), etc.) may be included in other system embodiments. In addition, it should be appreciated that the sat_images and UAV_images may be color images (even though illustrated herein in gray scale), whereby certain information of the color images may then be used as described herein. Further, it should be appreciated that the defined resolution images generated by the computing device 102, for example, from the sat_images, may also be color images (even though illustrated herein in gray scale).

With respect to FIG. 1, in particular, the satellite 108 is disposed in orbit about the Earth (which includes the fields 106 a-c) and is configured to capture images of one or more of the fields 106a-c. As indicated above, the satellite 108 may be part of a collection of satellites (including multiple companion satellites) that orbit the Earth and captures images of different fields, including the fields 106a-c. In this example embodiment, the satellites (including the satellite 108) form a network of satellites, which, individually and together, is/are configured to capture images, at an interval of once per N days, where N may include one day, two days, five days, seven days (i.e., weekly), ten days, 15 days, 20 days, 25 days, 30 days, numbers of days therebetween, more than 30 days, etc., thereby defining a temporal resolution of satellite images of (or captured for) the fields 106 a-c. In addition, the specific satellite 108 is configured to capture images at one or more specific spatial resolutions, for example, about one meter by about one meter per pixel, about three meters by about three meters per pixel, or more or less, depending on the particular satellite 108, etc. An image captured by the satellite 108, in this example, of one or more of the fields 106 a-c is schematically illustrated in FIG. 1 as image 120. The image 120 is broadly referred to herein as a “low (or lower) resolution image,” having a generally “lower spatial resolution” (e.g., having a spatial resolution of about one meter or more per pixel (e.g., a spatial resolution of about one meter by about one meter per pixel, about three meters by about three meters per pixel, about four meters by about four meters per pixel, a lower spatial resolution, etc.), etc.) and a generally “higher temporal resolution” (e.g., having a temporal resolution of about one week or less, etc.), for example, as compared to images captured by the UAV 110, etc.

The satellite 108 is configured to capture the images (including image 120) and to transmit the images to the database 104, either directly, or via one or more computing devices, etc. (e.g., via network 112 and computing device 102 as illustrated in FIG. 1, etc.). In at least one embodiment, the database 104 is configured to receive the images from the satellite 108 via a satellite image service (of which the satellite 108 may be a part), which coordinates, manages and/or relies on the satellite 108 (and other companion satellites in the given network of satellites). Such satellite image service may include, for example, PlanetScope from Planet Labs Inc., which provides a constellation of about 130 satellites (e.g., of which the satellite 108 may be one, etc.) configured to image an entire land surface of the Earth every day (e.g., providing a daily collection capacity of about 200 million km²/day, etc.) and which provide images having approximately three meters per pixel resolution. The database 104 is configured to receive and store the satellite images in memory thereof, in a suitable manner.

Consistent with the above, it should be appreciated that the database 104 includes a data set (or multiple data sets), which includes numerous satellite images received from the satellite 108 and from companion satellites of various fields, including the fields 106a-c, etc. (e.g., multiple sat_images, etc.). The data set (or each data set) including the satellite images may be organized, in the database 104, by location and/or by date/time, etc., as is suitable for use as described herein. In the embodiments herein, the data set of sat_images is understood to be an example of a relatively lower spatial resolution, higher temporal resolution data set, etc. And, more generally herein, such data set (including the sat_images) may be referred to as a low (or lower) resolution data set.

In addition in the system 100, the UAV 110 is configured to navigate to one or more fields, including the fields 106a-c, and to capture images of the fields. The UAV 110 is further configured to transmit the images to the database 104 (e.g., via network 112 and/or computing device 102, etc.), whereby the database 104 is configured to receive and store the images (in a similar manner to the images received from the satellite 108, etc.). It should be understood that while the UAV 110 is included in system 100, again, a MAV may be included in addition to or in place of the UAV 110 in other system embodiments. In general, in such embodiments, the MAV will capture and output images having spatial and temporal resolutions generally consistent with the UAV 110, a described herein.

Unlike the satellite images (as captured by the satellite 108), the images captured by the UAV 110, for example, may include a spatial resolution of less than about one inch by about one inch per pixel, etc. The specific spatial resolution may be, for example, without limitation, less than about 35 millimeters (or less than about 1.4 inches) per pixel, less than about 25.4 millimeters (or less than about one inch) per pixel, or more or less, depending on the particular UAV, etc. Additionally, a temporal resolution for the images captured by the UAV 110, for example, may be about one per year, twice per year, one per month, etc., depending on the operation of the UAV 110, the frequency of the UAV coverage of the fields 106a-c, etc. In general, the UAV 110 is configured to provide a more sparse temporal resolution than the satellite 108 (and its companion satellites) for reasons associated with travel time, availability, cost, etc. That said, an image captured by the UAV 110, in this example, of one or more of the fields 106a-c is schematically illustrated in FIG. 1 as image 118. The image 118 is broadly referred to herein as a “high (or higher) resolution image,” having a generally “higher spatial resolution” (e.g., having a spatial resolution of about ten inches or less per pixel, about five inches or less per pixel, about two inches (about five centimeters) or less per pixel (e.g., a spatial resolution of about two inches by about two inches per pixel or higher, about 0.4 inches by about 0.4 inches or higher, etc.), etc.) and a generally “lower temporal resolution” (e.g., having a temporal resolution of about six months or more, etc.), for example, as compared to images captured by the satellite 108, etc.

Similar to the above, the database 104 includes a data set (or multiple data sets), which includes numerous UAV images received from the UAV 110 of various fields, including the fields 106a-c, etc. (e.g., multiple UAV_images, etc.). As above, the data set (or each data set) including the UAV images may be organized by location and/or by date/time, etc., in the database 104, as is suitable for the use as described herein. In the embodiments herein, the data set of UAV_images is understood to be an example of a relatively higher spatial resolution, lower temporal resolution data set, etc. And, more generally herein, such data set (including the UAV_images) may be referred to as a high (or higher) resolution data set.

In connection with the above, in this example embodiment, the database 104 further includes a training data set of images compiled, collected, obtained, etc. specifically for (or of) the fields 106a-c, with the same or different crops therein. The training data set of images includes images received from the satellite 108 (e.g., sat_images, etc.) (broadly, low resolution images) and images received from the UAV 110 (e.g., UAV_images, etc.) (broadly, high resolution images). Further in this example, the images (of the training data set) include a weekly temporal resolution. And, the images are each designated in a manner so as to match the sat_images and the UAV_images based on location and time, i.e., images of the same field and/or part of the same field are designated as such so that similarly designated sat_images and UAV_images can be matched. As for area and/or location, the training data set includes images of specific sizes, in this example. The sat_images, for example, may be representative of an area (or plot) of about twenty-one by twenty-one meters, and may include a size of about six pixels by about six pixels with a spatial resolution of about 3.5 meters per pixel. And, the UAV_images, for example, may be representative of an area (or plot) of about twenty-one by twenty-one meters, and may include a size of about twenty-one thousand by twenty-one thousand pixels with a spatial resolution of about 1 cm per pixel (e.g., between about 0.5 cm and about 2 cm per pixel, etc.).

In the above example, the training data set includes the images as defined by various bands of wavelengths (e.g., spectral bands within the electromagnetic spectrum, etc.) representative of the images. For example, the images may include data (or wavelength band data or band data) related to the color red (e.g., having wavelengths ranging between about 635 nm and about 700 nm, etc.), the color blue (e.g., having wavelengths ranging between about 490 nm and about 550 nm, etc.), the color green (e.g., having wavelengths ranging between about 520 nm and about 560 nm, etc.), and near infrared (NIR) (e.g., having wavelengths ranging between about 800 nm and about 2500 nm, etc.), etc. That said, it should be appreciated that the images herein may be defined by any desired number of bands of wavelengths, for one band, three bands, five bands, ten bands, 15 bands, 20 bands, 30 bands, 50 bands, or more bands, etc. What's more, it should be appreciated that one or more bands of wavelengths herein may be different than the ranges provided above (e.g., may include different colors bands, visual or non-visual bands, or other bands (e.g., having wavelengths greater than 2500 nm, wavelengths less than 490 nm, and etc.), etc.).

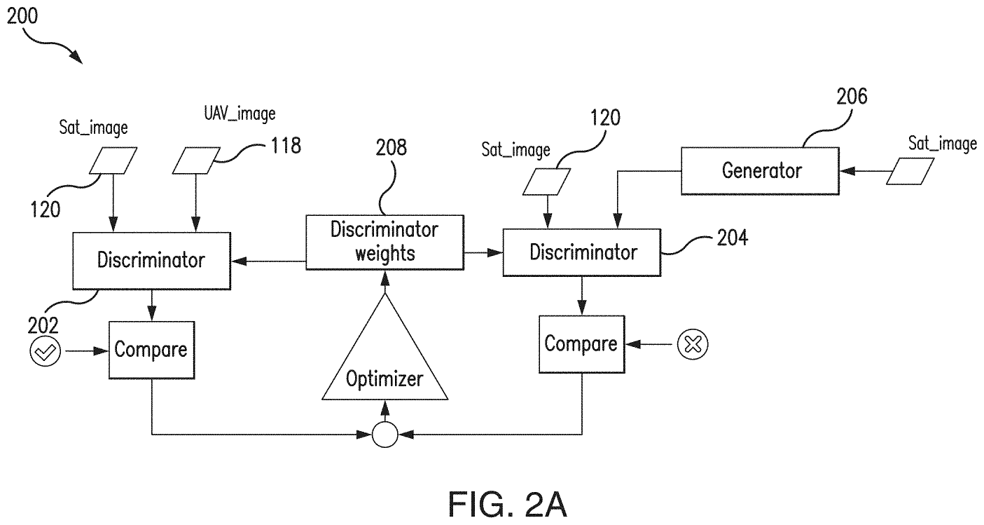

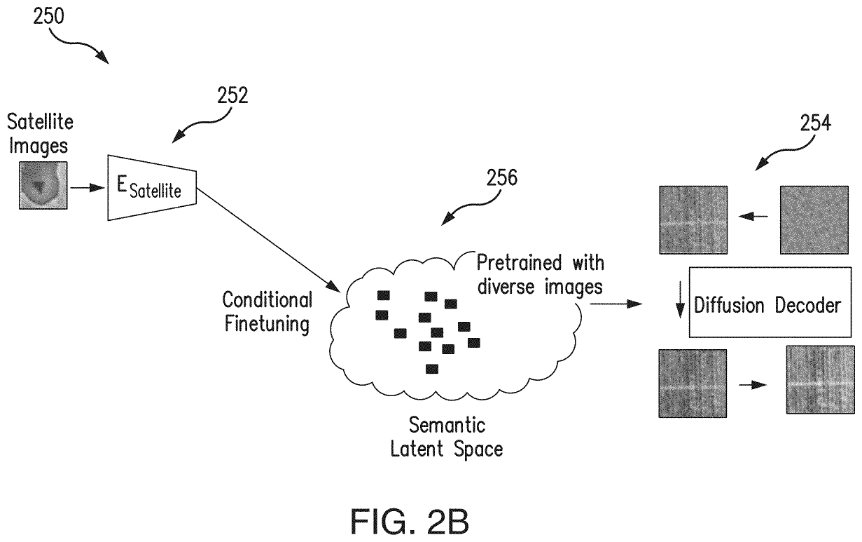

As part of learning to identify characteristics of crops in the fields 106a-c, the computing device 102 is configured to process (or pre-process, etc.) the images included in the training data set in the database 104 (e.g., all of the images, just the sat_images, just the UAV_images, etc.). In particular, for example, the computing device 102 may be configured to modify the band data for each image of the training data set as a mechanism for otherwise representing the images in connection with the learning (or modeling) herein (e.g., in connection with training discriminators 202, 204 and/or generator 206 of an image engine 200 (see, FIG. 2A) associated with and/or included with/in the computing device 102, in connection with training a denoising diffusion model of architecture 250 herein (see, FIG. 2B), etc.). For example, the computing device 102 may be configured to define each image in the training data set, for example, per pixel, as a combination of red, green, blue, and NIR band values. Table 1 illustrates a number of example combinations of different band data that may be defined, by the computing device 102, for each of the images (per pixel).

TABLE 1

Red/Green - Green/Blue - Red/Blue
Red/Green - Green/NIR - Red/NIR
Red/Blue - Blue/NIR - Red/NIR

It should be appreciated that the above-described data sets regarding the satellite images and the UAV images, as well as the training data sets including similar images, are example only, and that other data sets having other images of varying resolutions, spatial and/or temporal, may be included in the database 104 and relied on as described below in other embodiments. In addition, it should also be appreciated that the example combinations of band data included in Table 1, as part of training the computing device 102, is example only, and that other combinations may be used in other embodiments.

It should further be appreciated that, in some embodiments, the images captured by the satellite 108 and the UAV 110, as part of the low resolution and high resolution data sets, may be of a same one of the fields 106a-c (or plot), at approximately the same time (e.g., within one day, two days, one week, etc.) whereby the sat_images from the satellite 108 and the UAV_images from the UAV 110 may overlap and capture the same field (or plot). In connection therewith, then, the sat_images and the UAV_images may be combined and also included in the training data set (even though the sat_images and UAV_images were not specifically captured in connection with compiling the training data set).

Apart from the different data sets of images described above, the fields 106a-c may be associated with one or more sensors, which are disposed or configured to capture specific environmental metrics (or data) of (or for) the fields 106a-c. In FIG. 1, for example, the system 100 includes two weather stations 114a-b, which are configured to measure/detect and report weather conditions of the fields 106a-b. In particular, weather station 114a is associated with the field 106a, and weather station 114b is associated with the field 106b. The weather stations 114a-b may be configured to measure, and report, precipitation (e.g., rain, irrigation, etc.), air pressure, air temperature, soil temperature, humidity, wind, cloud cover, etc., for example, to the computing device 102 and/or the database 104 (via the network 112). The system 100 further includes a soil sensor 116 disposed at field 106c. The soil sensor 116 may be configured to measure, and report, moisture content, composition, density, type, temperature, pH, electric conductivity, etc. of soil in the field 106c, for example, to the computing device 102 and/or the database 104 (via the network 112). It should be appreciated that in other embodiments other, different sensors in various configurations, types, etc., may be employed in the fields 106a-c, in addition, or alternatively, to measure or capture the same or different environmental metrics of the fields 106a-c.

In connection therewith, the weather stations 114a-b and the soil sensor 116 (broadly, sensors) may be configured to measure or capture, and then report, metrics/data for the fields 106a-c at any suitable temporal resolution, including, for example, hourly, bi-daily, daily, bi-weekly, weekly, or more or less, etc. Like the image data provided by the satellite 108 and the UAV 110, the environmental metrics are received by the database 104, either directly from the weather stations 114a-b and/or the soil sensor 116 (e.g., via network 112, etc.), or indirectly, through one or more computing devices (e.g., in communication with the weather stations 114a-b and/or the soil sensor 116, etc.). The database 104, in turn, is configured to store the environmental metrics, generally, in association with the fields 106a-c.

From the above, the computing device 102 is configured to leverage the data/metrics stored in the database 104 to perform one or more assessments of the fields 106a-c (e.g., identify one or more characteristics of crops in the fields 106a-c, etc.). In doing so, in this example embodiment, the computing device 102 is configured to generate multiple defined resolution images of (or for) the fields 106a-c (or plots associated therewith) from the images (e.g., the sat_images, etc.) of the fields 106a-c included in the low resolution data set(s) in the database 104 (e.g., as captured by the satellite 108, etc.).

In connection therewith, the computing device 102 is initially trained by way of the training data set of images. In particular, the computing device 102 is configured to rely on one or more generative models to generate desired spatial resolution images (e.g., images having generally improved and/or higher spatial resolutions as compared to starting images or input images, etc.). That said, generative models are a class of probabilistic machine learning models that focus on an underlying probability distribution of data. In connection therewith, the input data provided to the generative models (e.g., the starting images from the satellite 108 (e.g., the sat_images, etc.), etc.) may be represented or generated by an associated unseen latent variable z, for example, which can be denoted (for example, illustrated) by random variable x. Through the generative models, then, generating samples from a joint probability distribution of parameters may be represented as p(x,z), where x is the random variable indicative of the observed data, z is the latent variable and p( ) is the probability function. The trained models can then be used to create image data (from lower resolution input images), for example, similar to the image data on which it was trained.

In one example, the computing device 102 may be configured to rely on a conditional generative adversarial network (CGAN) (broadly, a generative model) to build/compile a generator, which, in turn, is configured to generate the defined spatial resolution images (from the lower spatial resolution starting images or input images). In order to compile the generator, in this example embodiment, the computing device 102 is configured to rely on the example architecture illustrated in FIG. 2A of the image engine 200 (e.g., as implemented via the computing device 102, etc.). As shown, the image engine 200 generally includes two discriminators 202, 204 and generator 206 (e.g., each being a deep neural network, etc.). In this example, in particular, both the generator 206 and the discriminators 202, 204 use modules of the form convolution-BatchNorm-ReLu. However, it should be appreciated that other models and/or modules may be suitable and used in other embodiments.

Tables 2 and 3 illustrate example layers that may be included in, that may be part of, that may be representative of, etc. the engine 200 (e.g., as part of the neural network represented thereby, etc.) (see, e.g., Kulkarni, Aditya, et al. “Semantic Segmentation of Medium-Resolution Satellite Imagery using Conditional Generative Adversarial Networks.” arXiv preprint arXiv:2012.03093 (2020)). In particular, Table 2 illustrates example layers (e.g., each row represents a layer, etc.) (e.g., an example setup, etc.) that may be associated with the generator 206 (e.g., a generator architecture, etc.), and Table 3 illustrates example layers (e.g., each row represents a layer, etc.) (e.g., an example setup, etc.) associated with each of the discriminators 202, 204 (e.g., a discriminator architecture, etc.). In connection therewith, the input (or input shape) generally represents a size of input metrics to the given layer. The operations then generally represent a type of the layer. And, the output (or output shape) generally represents output metrics of the layer.

TABLE 2

| Block | Input | Operations | Output |
|---|---|---|---|
| 1 | 4 × 256 × 256 | Conv2D, LReLU | 64 × 128 × 128 |
| 2 | 64 × 128 × 128 | Conv2D, BN, LReLU | 128 × 64 × 64 |
| 3 | 128 × 64 × 64 | Conv2D, BN, LReLU | 256 × 32 × 32 |
| 4 | 256 × 32 × 32 | Conv2D, BN, LReLU | 512 × 16 × 16 |
| 5 | 512 × 16 × 16 | Conv2D, BN, LReLU | 512 × 8 × 8 |
| 6 | 512 × 8 × 8 | Conv2D, BN, LReLU | 512 × 4 × 4 |
| 7 | 512 × 4 × 4 | Conv2D, ReLU | 512 × 2 × 2 |
| 8 | 512 × 2 × 2 | ConvTrans2D, BN, | 512 × 4 × 4 |
| | | ReLU | |
| 9 | 1024 × 4 × 4 | ConvTrans2D, BN, | 512 × 8 × 8 |
| | | DO, ReLU | |
| 10 | 1024 × 8 × 8 | ConvTrans2D, BN, | 512 × 16 × 16 |
| | | DO, ReLU | |
| 11 | 1024 × 16 × 16 | ConvTrans2D, BN, | 256 × 32 × 32 |
| | | ReLU | |
| 12 | 512 × 32 × 32 | ConvTrans2D, BN, | 128 × 64 × 64 |
| | | ReLU | |
| 13 | 256 × 64 × 64 | ConvTrans2D, BN, | 64 × 128 × 128 |
| | | ReLU | |
| 14 | 128 × 128 × 128 | ConvTrans2D, | 6 × 256 × 256 |
| | | Softmax | |

TABLE 3

| Block | Input | Operations | Output |
|---|---|---|---|
| 1 | 10 × 256 × 256 | Conv2D, LReLU | 64 × 128 × 128 |
| 2 | 64 × 128 × 128 | Conv2D, BN, LReLU | 128 × 64 × 64 |
| 3 | 128 × 64 × 64 | Conv2D, BN, LReLU | 256 × 32 × 32 |
| 4 | 256 × 32 × 32 | Conv2D, BN, LReLU | 512 × 16 × 16 |
| 5 | 512 × 16 × 16 | Conv2D, Sigmoid | 1 × 8 × 8 |

As part of compiling the generator 206, the computing device 102 is configured to feed the training data set of images (from the database 104) into the discriminator 202, where the input includes corresponding pairs of sat_images and UAV_images for a particular one of the fields 106a-c or part of the field (e.g., for a particular plot, etc.). In this manner, the discriminator 202 (in conjunction with the discriminator 204) is configured to learn to discriminate between true corresponding pairs of relatively lower spatial resolution images and higher spatial resolution images (e.g., in order to learn to determine whether an input image is a real UAV_image or a simulated UAV_image from a given input sat_image, etc.), where, for the discriminator 202 (e.g., from a viewpoint of the discriminator 202, etc.), the pairs of input images are from the training data set, and therefore the images are known to be true corresponding pairs.

At the same time, the computing device 102 is also configured to provide sat_images to the generator 206 (as inputs to the generator 206), which is configured to generate defined resolution images based thereon (e.g., images having comparable spatial resolution quality to the UAV_images provided to the discriminator 202, etc.). And, the computing device 102 is additionally configured to input the same sat_images into the discriminator 204, and also the defined resolution images generated by the generator 206, as inputs thereto. In doing so, the discriminator 204 is configured to learn to discriminate between false corresponding pairs of lower resolution sat_images and higher resolution defined resolution images, where, for (or from the standpoint of) the discriminator 204, the defined resolution images are from the generator 206, and therefore, are part of false corresponding pairs if images (i.e., the defined resolution images presented to the discriminator 204 are the images generated by the generator 206 based on the input sat_images and thus are not actual UAV_images of the fields 106a-c corresponding to the sat_images).

As the generator 206 and discriminators 202, 204 proceed through the training, the computing device 102 is configured to alter the discriminators 202, 204, and in particular, weights 208 thereof, through comparisons of the guesses from the discriminators 202, 204 (i.e., regarding comparisons of the actual UAV_images corresponding to the given sat_images provided as inputs to the discriminator 202 and the defined resolution images generated by the generator 206 for the same given sat_images and provided to the discriminator 204), whereby the discriminators 202, 204 essentially work together against the generator 206 to improve the generated defined resolution images by improving, tuning, etc. weights of the network.

Similarly, the computing device 102 is configured to alter the generator 206 to become more successful in interacting with (e.g., fooling, generating better defined resolution images for input to, etc.) the discriminator 204. In general, the image engine 200 is configured to proceed consistent with a minimax algorithm, in this example, whereby the gain of the discriminators 202, 204 (collectively) is a loss to the generator 206, and vice-versa. The discriminators 202, 204 and the generator 206 continue iteratively until a convergence is achieved at an equilibrium (e.g., a Nash equilibrium, etc.), where neither has an advantage. In other words, training datasets of both UAV images and of satellite images converge together with the help of the generator 206 and the discriminators 202, 204. And, this becomes a supervised learning approach (or, more precisely, an adversarial learning approach) as the inputs are generally known (e.g., the supervision is loosely provided by the choice of known sat_images and known UAV images, etc.). When the discriminators 202, 204 and the generator 206 reach the equilibrium, via implementation of the training data set of images, as described, the generator 206 is compiled and trained for use as described below with regard to generation of defined resolution images (again, having comparable spatial resolution to the UAV_images described herein) from the given input sat_images.

With that said, more generally, the generator 206 (or generator model, etc.), for example, is configured to take a fixed-length random vector as input and generate a sample in the domain. In connection therewith, the vector may be drawn generally randomly from a Gaussian distribution, and the vector is used to seed the generative process. After training, then, points in the multidimensional vector space correspond to points in the problem domain, forming a compressed representation of the data distribution (e.g., a representation of UAV images in the example system 100, etc.). In other words, in this embodiment, the generator 206 is configured to map the latent space vector to data-space. In the system 100, for example, using a random distribution of vector z from satellite images, the generator 206 may be configured to convert the vector z to data-space to thereby create a UAV image with the same size as the dimension of the training images. The output of the generator may then be fed through a tan h function to return it to the input data range of [−1,1]. To that end, the generator 206 may be associated with one or more weights and values that can be determined and/or manipulated as appropriate to function as described herein (as would generally be apparent to one skilled in the art in view of the present disclosure).

It should be appreciated that other architectures, and other networks, may be employed to compile a generator (of an image engine) suitable for use as described herein. What's more, it should be appreciated that the generator 206 of the image engine 200 (in the architecture illustrated in FIG. 2A), for example, may be trained for specific crops (e.g., soybeans versus corn, etc.), and further for different regions.

In another example, the computing device 102 may be configured to rely on a diffusion model, including, for example, a denoising diffusion model (or denoising diffusion probabilistic model), etc. (which is also referred to as a generative model), to generate the defined spatial resolution images (from the lower spatial resolution starting images or input images). The denoising diffusion model defines a chain of steps to slowly add random noise to image data, for example, (e.g., as part of forward diffusion, etc.) and at the same time learn an inverse process to reverse the diffusion of noise. This reverse process to denoise the images is learned by a deep neural net.

In implementing (and training) the diffusion model (e.g., as part of adding random noise to an input sample during forward diffusion, etc.), the diffusion model starts with the observed data for a sample x at timestep 0 (e.g., a starting sat_image received from satellite 108, etc.) and (at a first step (or timestep 1)) adds a preconfigured amount of noise thereto (e.g., to x₀, etc.) to produce a subsequent sample at timestep 1, x₁. Here, x₀˜q(x) is a sample from an unknown real data distribution q(x). This process is then repeated for a fixed number of timesteps T (e.g., as part of a time dependent schedule including dozens, hundreds or thousands of timesteps, etc.) producing a sequence of noisy samples x₁, . . . , x_{T} until x_{T} is indistinguishable from pure noise. In this example, the time dependent schedule includes a fixed variance schedule {βᵢ∈(0,1)}₁^{T}.

In this forward diffusion process, each timestep t corresponds to a certain noise level (e.g., where t˜Uniform({1, . . . , T}), etc.) and xₜ is viewed as a mixture of a signal x₀ and some noise eₜ. The sequential, repeated process of adding noise to the original sample defines a Markov chain, in which each state is a sample from a transition probability distribution q(xₜ|xₜ₋₁). The noise added, in this example, is Gaussian noise and therefore, each transitional sample is a Gaussian conditioned on a previous time step with variance according to the variance schedule β, for example, q(xₜ|xₜ₋₁)=N(xₜ; \sqrt{1−βₜ}xₜ₋₁, βₜI).

Once noise is added to the input sample in accordance with the fixed number of timesteps, the diffusion model proceeds to reverse the diffusion of noise with regard to the input sample, or sat_image. This is done by sampling from the probability distribution q(xₜ₋₁|xₜ), which is modeled by neural net model p_{θ} where p_{θ(x}_{_{0:T}}₎=p(x_{T})Πₜ₌₁^{T}p_{θ}(xₜ₋₁|xₜ). In doing so, then, for each time step, p_{θ}(xₜ₋₁|xₜ)=N(xₜ₋₁; μ_{θ}(xₜ, t), σ_{θ}(xₜ, t)). The model p_{θ(x}_{_{0:T}}₎ is trained by attempting to minimize the difference to q, using the variational lower bound to optimize the negative log-likelihood based on the following:

$$- log {p}_{θ} ( {x}_{0} ) \leq {𝔼}_{q} [ log \frac{q ( {x}_{1 : T} \vert {x}_{0} )}{{p}_{θ} ( {x}_{0 : T} )} ] = {ℒ}_{VLB}$$

In the above, [symbol] _{VLB} may also be expressed as a sum of L_{T}+L_{T-1}+ . . . +L₀, where:

L_{T}=D_{KL}(q(x_{T}|x₀)p_{θ}(x_{T}));
D_{KL} is Kullback-Leibler divergence;

Lₜ=D_{KL}(q(xₜ|xₜ₊₁,x₀)∥p_{θ}(xₜ|xₜ₊₁)) for 1≤t≤T−1; and

L₀=−log p_{θ}(x₀|x₁).

In addition, in the above equations, the KL terms are comparisons between Gaussians and, since the variance terms are fixed, schedule L_{T} becomes a constant. For example:

Lₜ^{simple}= [symbol] _{t˜[1,T],x}_{₀}_{,∈}_{ₜ}[∥∈ₜ−∈_{θ}(xₜ,t)∥²],

where the neural net parameterized by θ is the denoising model used to predict the gaussian noise ∈′ₜ and takes the form ∈_{θ}(xₜ, t) (see, Jonathan Ho, “Denoising Diffusion Probabilistic Models,” 2020).

With that said, training of the diffusion model occurs at each timestep of the forward diffusion process. As such, the trained diffusion model may be configured to start from any suitable noisy sample (e.g., any suitable image, etc.) at any of the different timesteps and reverse the noise to achieve the original sample. Training, as described above, may include (without limitation) the operations provided in Table 4.

TABLE 4

1: Repeat forward diffusion
2: x₀ ~ q(x₀)
3: t ~ Uniform({1, ..., T})
4: ∈ ~ N(0, I)
5: Take gradient descent step on ∇_{θ}|| ∈ − ∈_{θ}(\sqrt{αₜx₀} +
\sqrt{1 − αₜ∈, t}) ||²
where αₜ = 1 − βₜ
6: until converged

Once the diffusion model is trained on image data, it may be used to generate a defined spatial resolution image from a starting image, for example (and without limitation), in accordance with the operations provided in Table 5.

TABLE 5

1: x_{T}~ N(0, I)
2: for t = T, ... 1 do
3: z ~ N(0, I) if t > 0, else z = 0
$4 : {x}_{t - 1} = \frac{1}{\sqrt{{α}_{t}}} ( {x}_{t} - \frac{( 1 - {α}_{t} )}{\sqrt{1 - {α}_{t}}} {ϵ}_{θ} ( {x}_{t} , t ) + {σ}_{t} z$
5: end for
6: return x₀

FIG. 2B illustrates an example architecture 250 that may be used in implementing (e.g., via the computing device 102, etc.) the denoising diffusion model described herein. As shown, the architecture 250 includes an encoder 252 and a decoder 254. The encoder is configured, for example, to condition input satellite image data (e.g., a sat_image, etc.) as generally described herein. And, the decoder 254 then is configured to generate the defined spatial resolution images based on the input satellite image data. More particularly, the encoder 252 is configured to receive the satellite image data and generate (or create) a representation (or representations) in semantic latent space 256 that is used by the decoder 254 to generate a corresponding defined spatial resolution image (or images).

In the diffusion model, the input and output dimension of the model is the same in height and width. As such, a UNet model may be used as the decoder 254, for example, as specified in GLIDE (Guided Language-to-Image Diffusion for Generation and Editing) from OpenAI (see, e.g., Nichol et al., “GLIDE: Towards Photorealistic Image Generation and Editing with Text-Guided Diffusion Models,” 2022; etc.).

In connection therewith, in application of the diffusion model to the images described herein, a condition, y, may be added, for instance, in the form of an input satellite image. The model then becomes ∈_{θ}(xₜ, y, t), where the condition information may be injected through input concatenation. A two stage training scheme is then used, where a base diffusion model is trained at 64×64 resolution, followed by an up sampling model to go from 64×64 to 256×256. The generation using the base diffusion model may be, schematically, xₜ=Dec(Enc(x₀, y)), where Dec and Enc denote the pretrained denoising diffusion model and the pretrained task specific head Encᵢ to map the conditional input into the pretrained embedding space. And then, fine-tuning is done in two stages. In the first stage, the Encᵢ is trained leaving the Dec intact. In the second stage, both Dec and Encᵢ are jointly trained.

After training (regardless of the particular model used), the computing device 102 is configured to ingest sat_images (e.g., from the satellite 108, etc.) (including images of the fields 106a-c, or parts thereof) daily or weekly (or at some other interval). The computing device 102 may be configured to pre-process the sat_images, as necessary or desired (e.g., to combine band data, etc.). And then, the computing device 102 is configured to employ the model (e.g., the generator 206, etc.), for example, to up-sample the images and/or to generate desired defined resolution images from a data set of the sat_images (e.g., to generate images having comparable UAV spatial resolution quality from the input sat_images, etc.).

In turn, the computing device 102 is configured to identify the generated defined resolution images to the specific geolocations of the fields 106a-c (broadly, plots), or parts thereof, to which the images correspond, for example, based on defined geo-plots or location definitions for the fields 106a-c or parts thereof. In this manner, each of the defined resolution images are correlated on a plot level to the one or more fields 106a-c or parts thereof. More generally, each of the images are correlated to one or more plots, for example, and identified to the specific plot (e.g., a specific one of the fields 106a-c, or a part of the field, etc.). The computing device 102 may therefore be configured to clip or crop each of the defined resolution images to one or more specific plots (e.g., where the images include multiple plots, etc.) (e.g., to generate one or more field level images for the fields 106a-c, etc.). The computing device 102 is configured to then store the defined resolution images, as associated with the corresponding plots or locations, in memory (e.g., in the database 104, etc.).

In this example embodiment, the computing device 102 is configured to determine or compile index values for each of the defined resolution images (e.g., for the given one or more of the fields 106a-c represented in the images, etc.), including, for example, normalized difference vegetative index (NDVI) values. The NDVI values, for example, are based on a combination of the band data for the images (e.g., (NIR−red)/(NIR+red), etc.). In connection therewith, the NDVI values may be used to quantify vegetation greenness, for example, or other parameters of the fields 106a-c and/or crops planted in the fields 106a-c (e.g., relating to health of the crops, growth of the crops, growth stages of the crops, etc.) as represented in the images. It should be appreciated that other standard, or non-standard, index values may be determined and/or compiled to evaluate health and/or growth of crops from the images, or band data associated therewith, including, for example, visual atmospheric resistance index (VARI) values, triangular greenness index (TGI) values, etc.

The computing device 102 is further configured to aggregate the index values for the fields 106a-c (as generated for the defined resolution images thereof) with one or more other environmental metrics associated with the fields 106a-c identified in the images, or the specific images and/or geolocations identified thereto, etc. The environmental metrics may include, for example, precipitation, diurnal temperature ranges, solar radiation, etc. captured and/or measured by the weather station 114a-b, for example, or other environmental metrics, such as those captured and/or measured by the soil sensor 116, etc. The aggregation may include (or may be implemented via) inverted variance weighting, convolutional neural networking (CNN), etc. Further, in some embodiments, the computing device 102 may be configured to aggregate the index values and the environmental metrics into a combined metric, for example, for a given data set of sat_images (whereby the combined metric may be representative of, assigned to, etc. one or more of the fields 106a-c represented by the given data set of sat_images), thereby encoding the environmental variables and phenotypic aspects from the corresponding defined resolution images for the data set.

Finally in the system 100, in this example, the computing device 102 is configured to determine one or more crop characteristics, at the plot level, for example, from the index values, the environmental metrics, and/or the aggregate value thereof, for the crop(s) identified in (or represented by) the input sat_images. The crop characteristics, for example, may include a yield prediction for the crop(s), general or per a specific date, as a mechanism for selecting harvest date(s) for the crop(s), treatment date(s) for the crop(s) (e.g., fertilizer treatment, pesticide treatment, etc.), etc., or as a mechanism for determining maturity date(s) for the crop(s), determining growth stage(s) for the crop(s), etc. The crop characteristic may include other characteristics in other embodiments.

Further, in some implementations of the system 100, the computing device 102 (e.g., via implementation of the generator 206, via the architecture 250, etc.) may be configured to utilize satellite images from the satellite 108, for example, to fill in (or supplement) prior (or historical) crop characteristic data for crops previously grown, previously harvested, etc., based on historical satellite images of fields including the crops, where no UAV images are available, or where no growth stage modeling, or quality control and/or outlier detection for satellite and/or UAV images was previously available, etc.

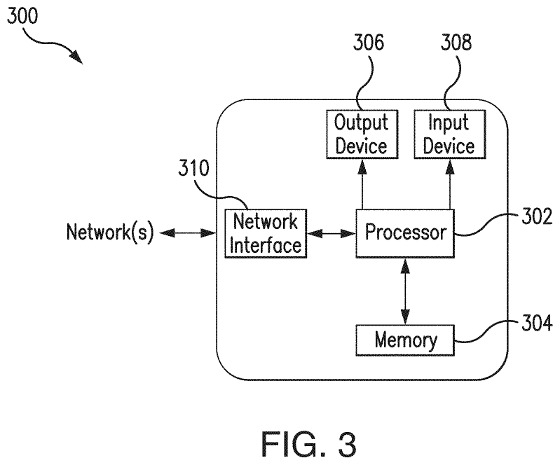

FIG. 3 illustrates an example computing device 300 that may be used in the system 100 of FIG. 1. The computing device 300 may include, for example, one or more servers, workstations, personal computers, laptops, tablets, smartphones, virtual devices, etc. In addition, the computing device 300 may include a single computing device, or it may include multiple computing devices located in close proximity or distributed over a geographic region, so long as the computing devices are specifically configured to operate as described herein. In the example embodiment of FIG. 1, the computing device 102, the database 104, the satellite 108, the UAV 110, the weather stations 114a-b, and the soil sensor 116 may each include and/or be implemented in one or more computing devices consistent with (or at least partially consistent with) computing device 300. However, the system 100 should not be considered to be limited to the computing device 300, as described below, as different computing devices and/or arrangements of computing devices may be used. In addition, different components and/or arrangements of components may be used in other computing devices.

As shown in FIG. 3, the example computing device 300 includes a processor 302 and a memory 304 coupled to (and in communication with) the processor 302. The processor 302 may include one or more processing units (e.g., in a multi-core configuration, etc.). For example, the processor 302 may include, without limitation, a central processing unit (CPU), a microcontroller, a reduced instruction set computer (RISC) processor, a graphics processing unit (GPU), an application specific integrated circuit (ASIC), a programmable logic device (PLD), a gate array, and/or any other circuit or processor capable of the functions described herein.

The memory 304, as described herein, is one or more devices that permit data, instructions, etc., to be stored therein and retrieved therefrom. In connection therewith, the memory 304 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media for storing such data, instructions, etc. In particular herein, the memory 304 is configured to store data including and/or relating to, without limitation, images (e.g., sat_images, UAV_images, defined resolution images, etc.), generators/discriminator models, generators for compiling defined resolution images, environmental metrics, and/or other types of data (and/or data structures) suitable for use as described herein. Furthermore, in various embodiments, computer-executable instructions may be stored in the memory 304 for execution by the processor 302 to cause the processor 302 to perform one or more of the operations described herein (e.g., one or more of the operations of method 400, etc.) in connection with the various different parts of the system 100, such that the memory 304 is a physical, tangible, and non-transitory computer readable storage media. Such instructions often improve the efficiencies and/or performance of the processor 302 that is performing one or more of the various operations herein, whereby such performance may transform the computing device 300 into a special-purpose computing device. It should be appreciated that the memory 304 may include a variety of different memories, each implemented in connection with one or more of the functions or processes described herein.

In the example embodiment, the computing device 300 also includes an output device 306 that is coupled to (and is in communication with) the processor 302. The output device 306 may output information (e.g., crop characteristics, metrics, defined resolution images, etc.), visually or otherwise, to a user of the computing device 300, such as a researcher, grower, etc. It should be further appreciated that various interfaces (e.g., as defined by network-based applications, websites, etc.) may be displayed at computing device 300, and in particular at output device 306, to display certain information to the user. The output device 306 may include, without limitation, a liquid crystal display (LCD), a light-emitting diode (LED) display, an organic LED (OLED) display, an “electronic ink” display, speakers, etc. In some embodiments, output device 306 may include multiple devices. Additionally or alternatively, the output device 306 may include printing capability, enabling the computing device 300 to print text, images, and the like on paper and/or other similar media.

In addition, the computing device 300 includes an input device 308 that receives inputs from the user (i.e., user inputs) such as, for example, selections of fields, desired characteristics, etc. The input device 308 may include a single input device or multiple input devices. The input device 308 is coupled to (and is in communication with) the processor 302 and may include, for example, one or more of a keyboard, a pointing device, a touch sensitive panel, or other suitable user input devices. In addition, the input device 308 may include, without limitation, sensors disposed and/or associated with the computing device 102. It should be appreciated that in at least one embodiment an input device 308 may be integrated and/or included with an output device 306 (e.g., a touchscreen display, etc.).

Further, the illustrated computing device 300 also includes a network interface 310 coupled to (and in communication with) the processor 302 and the memory 304. The network interface 310 may include, without limitation, a wired network adapter, a wireless network adapter, a mobile network adapter, or other device capable of communicating to one or more different networks (e.g., one or more of a local area network (LAN), a wide area network (WAN) (e.g., the Internet, etc.), a mobile network, a virtual network, and/or another suitable public and/or private network capable of supporting wired and/or wireless communication among two or more of the parts illustrated in FIG. 1, etc.) (e.g., network 112, etc.), including with other computing devices used as described herein.

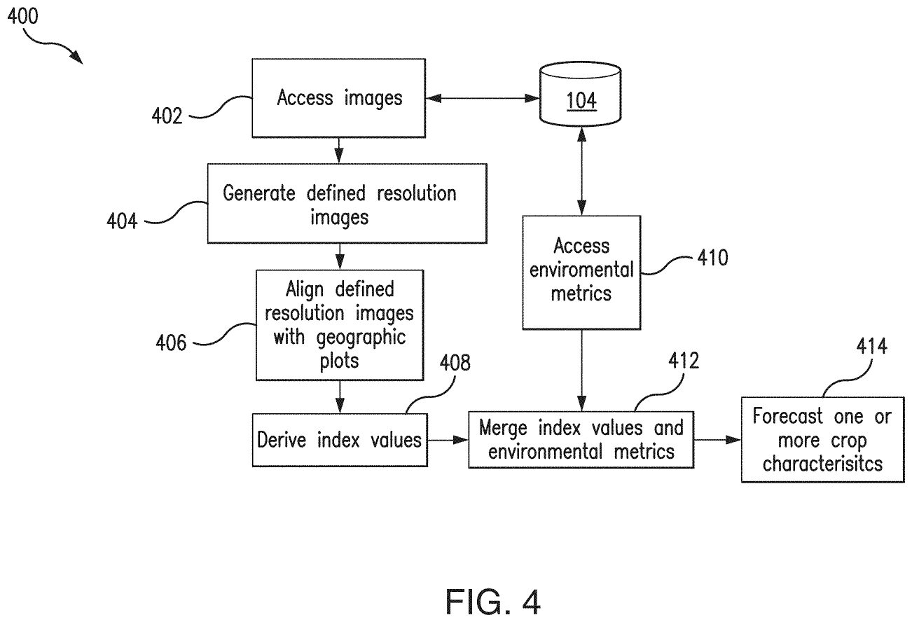

FIG. 4 illustrates an example method 400 for identifying one or more crop characteristics, from images (e.g., satellite images, lower spatial resolution images, etc.) associated with fields in which the crops are grown and/or located. The method 400 is described herein in connection with the system 100, and may be implemented, in whole or in part, in the computing device 102 of the system 100. Further, for purposes of illustration, the example method 400 is also described with reference to the computing device 300 of FIG. 3. However, it should be appreciated that the method 400, or other methods described herein, are not limited to the system 100 or the computing device 300. And, conversely, the systems, data structures, and the computing devices described herein are not limited to the example method 400.

At the outset, it should be appreciated that a model (e.g., as the generator 206, the diffusion model of architecture 250, etc.) is compiled and/or trained for one or more regions and/or crops, which are indicative of one or more of the fields 106a-c (e.g., via the architecture described above and illustrated in FIG. 2A with regard to the image engine 200 or FIG. 2B with regard to the architecture 250, etc.). In addition in this particular embodiment, the model is trained for soybeans in the region of the fields 106a-c. In other embodiments, the model may be trained for corn or other desired crop.

That said, at 402 in the method 400, the computing device 102 accesses, form the database 104, images for a desired one (or more) of the fields 106a-c (broadly, the fields of interest), for example, field 106a in the following example. The accessed images, in this example, include images captured by the satellite 108 (and/or other satellites in network therewith, etc.), and provided to (or retrieved by) the database 104, etc. As such, in this example, the accessed images are part of a low resolution data set of images for the field 106a, including the sat_images thereof. In connection therewith, the accessed images generally have a spatial resolution of about three meters per pixel, and a temporal resolution of about one week (or about seven days), one month (or about 30 days), etc. However, as described above, the spatial and/or temporal resolution of the images accessed by the computing device 102 may be different in other embodiments. In general, though, the images accessed at step 402 include a relatively lower spatial resolution, for example, of about one meter or more per pixel, etc.

As part of accessing the images, the computing device 102 may also segregate the images into suitable segments (e.g., for input to the generator 206, to the architecture 250, etc.). For example, for the field 106a, the images thereof may be segregated, clipped, cropped, reduced, etc., into about six pixel by six pixel segments, which constitutes about 18 meter by 18 meter segments of the given field 106a (or plot), for example. It should be appreciated that in various examples, the images may be segregated, clipped and/or shaped otherwise, as needed, to focus on the specific fields (or plots or crops therein) of interest (e.g., for a specific experiment, breeding directive, etc.).

At 404, the computing device 102 then generates defined resolution images, from the accessed images, through use of the trained model (e.g., the trained generator 206, the trained diffusion model associated with the architecture 250, etc.). The defined resolution (of the defined resolution images), in this example, is about one inch per pixel. It should be appreciated that the defined resolution may be otherwise in other embodiment, but generally the defined resolution is at least about ten inches or less per pixel.

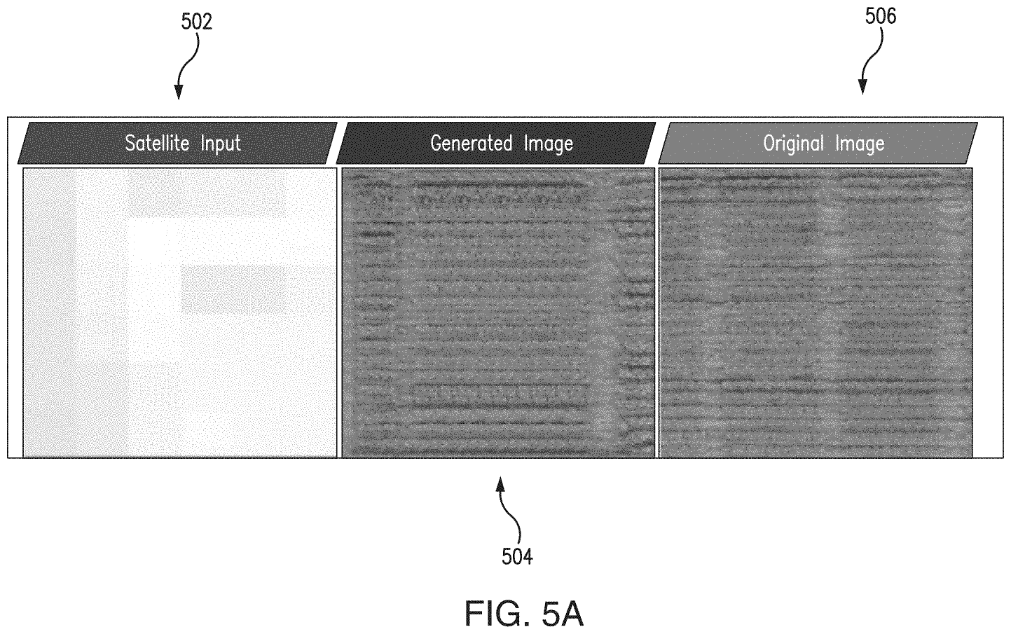

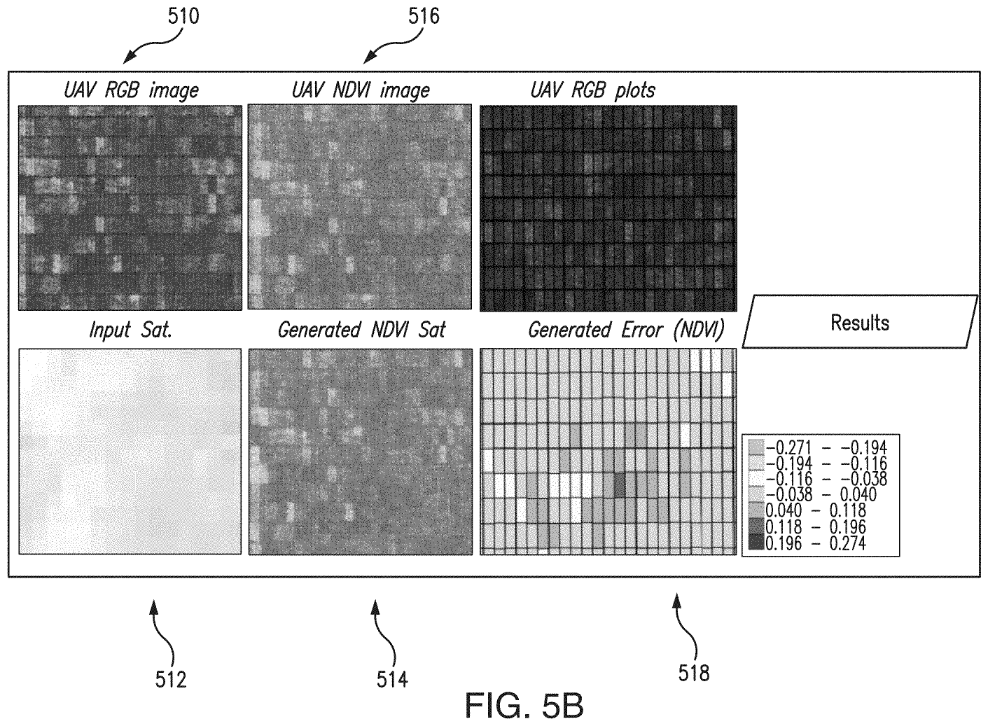

FIG. 5A illustrates an example sat_image 502 (broadly, an input image) that may be accessed from the database 104, having a relatively lower spatial resolution, for example, of about three meters per one pixel and a size of about six pixels by about six pixels (representing a segment of about 18 meters by about 18 meters of the field 106a). FIG. 5A also illustrates a defined resolution image 504 (e.g., a simulated image, a simulated UAV image, etc.), generated by the generator 206, for example, from the sat_image 502 (e.g., at operation 404 in the method 400, etc.), which includes a spatial resolution of about one cm per pixel and a size of about 18,000 pixels by about 18,000 pixels (and also representing the same segment of about 18 meters by about 18 meters of the field 106a as the original sat_image 502). For purposes of validation/illustration, then, FIG. 5A further includes an actual UAV_image 506 of the same specific segment of the field 106a represented by the sat_image 502. As can be seen, the defined resolution image 504 is consistent with the actual UAV_image 506. It should be appreciated that the example sat_image 502 and UAV_image 506 are color images (even though illustrated herein in gray scale), whereby certain information of the color images may then be used as described herein. In addition, it should be appreciated that the example defined resolution image 504 may also be a color image, whereby certain information of the color images may then be used as described herein.

While visual inspection indicates the accuracy of the generator 206 in FIG. 5A, it should be appreciated that calculated error is also indicative of the accuracy of the generator 206, for example, trained consistent with the description herein. FIG. 5B illustrates a UAV image 510 (upper/left) (where the grid lines generally represent boundaries of plots) and a SAT image 512 (lower/left), from which a UAV image 514 (or defined resolution image) is generated by the generator 206 described herein. The NDVI, in this example, is calculated, per pixel (or segment) for the actual UAV image (at 516) (upper/middle) and the generated UAV image 514 (lower/middle). The image 518 (lower/right) indicates the differences between the respective NDVI values. As shown, more than about 80% of the NDVI values from the generated UAV image are within ±0.04 of the NDVI values from the UAV image. The accuracy of the generated UAV image, in this example, is clearly apparent.

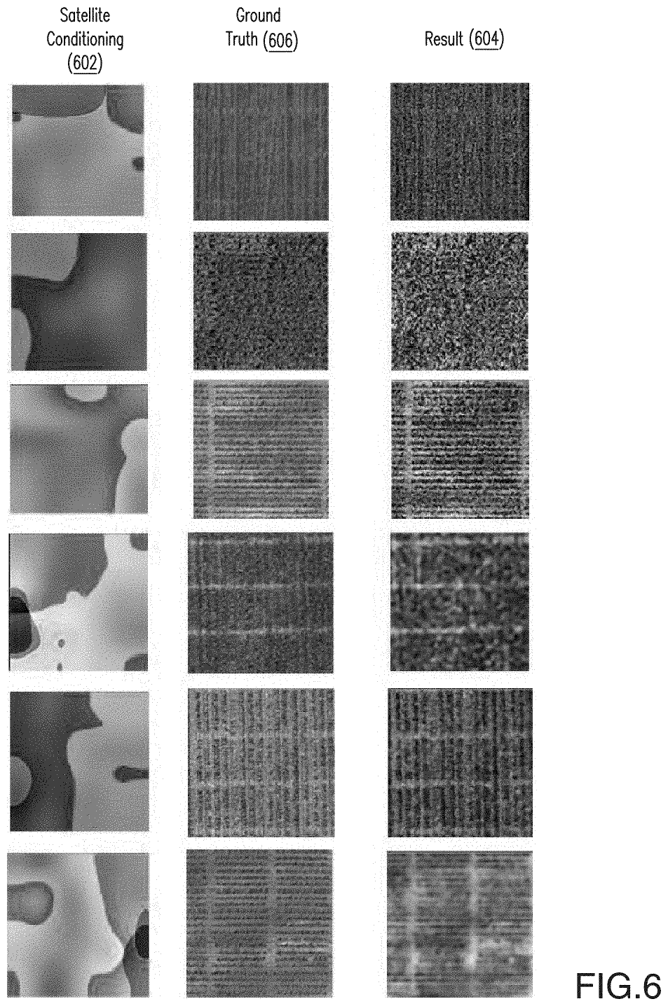

The same validations may be applied to the diffusion model associated with architecture 250 (for defined resolution images generated thereby). For instance, FIG. 6 illustrates multiple example conditioned satellite images 602 (or sat_images) (broadly, input images) (e.g., the conditioned images may be the actual satellite images input to the system 100, etc.) accessed from the database 104, and having a relatively lower spatial resolution (e.g., about three meters per one pixel and a size of about six pixels by about six pixels (representing a segment of about 18 meters by about 18 meters of the field 106a), etc.), as compared to the ground truth images 606 (e.g., UAV_images of the field 106a, etc.), which generally represent the same field at the same time. The combination of the sat_images and the UAV_images are used, for example, in training (or validation), as explained above. FIG. 6 then also illustrates corresponding defined resolution images 604 (e.g., a simulated image, a simulated UAV image, etc.), generated by the diffusion model, from each of the satellite images (e.g., at operation 404 in the method 400, etc.). The simulated images include a spatial resolution of about one cm per pixel and a size of about 18,000 pixels by about 18,000 pixels (and also representing the same segment of about 18 meters by about 18 meters of the field 106a as the original sat images 602). As can be seen, the defined resolution images 604 are consistent with the actual UAV images 606.

Next in the illustrated method 400, the computing device 102 aligns the generated defined resolution images to specific geographic plots, at 406. In particular, the defined resolution images are resolved against geographic definitions of specific plots (e.g., included in the field 106a, based on geographic data for the input sat_images, etc.), and consequently, the computing device 102 may again crop, segregate, clip or otherwise modify each of the defined resolution images to be consistent with one or more of the specific geographic definitions of the corresponding plot (e.g., to generate one or more field level images for the field 106a, etc.). The defined resolution images are then stored in memory (e.g., in the database 104, in other memory 304 associated with the computing device 102, etc.). That said, it should be appreciated that such aligning operation is optional and, as such, may be omitted in some embodiments.

At 408, the computing device 102 derives one or more different index values for the field 106a based on the defined resolution images generated therefor (e.g., one index value per image, one index value per multiple images, etc.). The index value(s) may include, for example, one or more of the NDVI value, the VARI value, the TGI value, etc., as explained above, where the images are expressed as a value relative to the index. In this example embodiment, the defined resolution images are subject to a formula consistent with the NDVI, whereby the index for each of the images, at a pixel level, is represented as a difference between the NIR wavelength band and the red wavelength band divided by a sum of the NIR wavelength band the red wavelength band (e.g., index value=(nir−red)/(nir+red), etc.). In connection therewith (as shown in FIG. 5B, for example), the NDVI value may be employed, for example, to quantify vegetation greenness of a crop (or crops) in the field 106a and may be useful in understanding vegetation density and assessing changes in plant health and growth of the crop(s) in the field 106a (e.g., over time, etc.).

Additionally, at 410, the computing device 102 accesses one or more environmental metrics from the database 104. The environmental metrics are specific to the field 106a, generally, and in particular to the plot(s) defined by the defined resolution images. The metrics may include, as explained above, for example, precipitation, temperature, solar radiation, etc. The environmental metrics are then merged, at 412, by the computing device 102 with the index values for the field 106a (and corresponding images), into a combined metric for the field 106a, as represented by each of the images (or, alternatively, into a combined metric representative of all of the images corresponding with the input data set of images). In this example, the metrics and index values are merged through suitable techniques, including, for example, inverted variance weighting, CNN, time series LSTM, Random Forest, etc. Consequently, the index values and metrics are encoded into combined metrics or values for the images (or, in some examples, into a combined metric for the plot (or field 106a or portion thereof) represented by the defined resolution images (and/or data set of sat_images upon which the defined resolution images are based).

Then, at 414 in the method 400, the computing device 102 forecasts one or more crop characteristics for the crop(s) in the field 106a based on the combined metrics for each of the defined resolution images (or combined metric for the underlying data set of sat_images). The crop characteristics may include, for example, yield, harvest date, harvest moisture, etc. In various embodiments, the computing device 102 relies on the one or more environmental metrics, temporally dense NDVI and/or image values from the generated images, as a temporal time series, in modeling the crop characteristics. For example, for yield prediction, within a growing season, the model is employed to generate defined resolution images from SAT_images, thereby defining image data at a higher resolution, but at a temporal resolution of the SAT_images, as a basis for a prediction. As the growing season progresses, the prediction becomes more accurate as additional defined resolution images are incorporated into the prediction.

It should be appreciated that the method 400 may be iterative, whereby the method 400 is repeated at one or more intervals. For example, the method 400 may be repeated weekly, bi-weekly, monthly, etc., whereby the metric(s) are more robust and provide enhancement to forecasting the crop characteristics, in step 414. Consequently, the images may be analyzed for any given point in time to predict a crop characteristic, or the images may be analyzed as a time-series, for example, to enhance prediction based thereon. For example, NDVI values may be tracked, through the time-series images (e.g., to define NDVI values over time, per pixel, plot, etc.), and provide more accurate basis for yield prediction (in this example, as compared to prediction based on a single point in time).

In view of the above, the systems and methods herein provide for generating defined resolution images (at a plot level) from lower resolution images (e.g., sat_images, etc.), in connection with forecasting crop characteristics for a plot. In doing so, the systems and methods herein may provide detailed and resource efficient temporal and spatial information indicative of various features, through the lower resolution images, which is not possible conventionally. Moreover, the systems and methods may permit for assessment of the images through an alternative spatial band, as compared to conventional bands, whereby fewer bands may be used/requested as compared to conventional multi-spectral sensors.

What's more, through such use of the lower resolution images, the systems and methods herein may alleviate impacts associated with conventionally requiring higher resolution images (e.g., UAV_images, etc.) to perform such evaluations, which such higher resolution images typically have sparse temporal resolution (e.g., due to limited resources, weather constraints, boundary constraints (e.g., ownership, country borders, etc.), etc.) that may impede the image-based forecasting of crop characteristics based thereon. In this manner, the systems and methods herein are permitted to rely on defined resolution images established from the lower resolution images, which, potentially, have more dense temporal information, in forecasting of crop characteristics at the plot level. As such, images of a higher spatial resolution of about one inch by about one inch per pixel may still be used in assessing the plot, despite the underlying input images having lower spatial resolution.

Further, the crop characteristics achieved via the systems and methods herein may be employed in a variety of different implementations. For example, in one implementation, the characteristics may be indicative of phenotypic traits of the crops (which may otherwise require extensive information for predicting), and utilized in selecting crops for harvest, treatment, etc.

With that said, it should be appreciated that the functions described herein, in some embodiments, may be described in computer executable instructions stored on a computer readable media, and executable by one or more processors. The computer readable media is a non-transitory computer readable media. By way of example, and not limitation, such computer readable media can include RAM, ROM, EEPROM, CD-ROM or other optical disk storage, magnetic disk storage or other magnetic storage device, or any other medium that can be used to carry or store desired program code in the form of instructions or data structures and that can be accessed by a computer. Combinations of the above should also be included within the scope of computer-readable media.

It should also be appreciated that one or more aspects, features, operations, etc. of the present disclosure may transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques, including computer software, firmware, hardware or any combination or subset thereof, wherein the technical effect may be achieved by performing at least one of the following operations: (a) accessing a first data set, the first data set including images associated with one or more fields, the images having a spatial resolution of about one meter or more per pixel; (b) generating, based on a generative adversarial network (GAN) model, defined resolution images of the one or more fields from the first data set, the defined resolution images each having a spatial resolution of about X centimeters per pixel, where X is less than about 5 centimeters; (c) deriving index values for the one or more fields, based on the defined resolution images of the one or more fields; (d) aggregating the index values for the one or more fields with at least one environmental metric for the one or more fields; (e) predicting a plot yield for the one or more fields, based on the aggregated index values and the at least one environmental metric; (f) storing the predicted yield for the one or more fields in a memory; (g) defining a field level image for each of the one of more fields, from the defined resolution images; (h) accessing a training data set, the training data set include a high resolution data set and a low resolution data set; and (i) training the GAN model, based on at least a portion of the high resolution data set and the low resolution data set.

Examples and embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more example embodiments disclosed herein may provide all or none of the above mentioned advantages and improvements and still fall within the scope of the present disclosure.

Specific values disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may also be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “in communication with,” or “included with” another element or layer, it may be directly on, engaged, connected or coupled to, or associated or in communication or included with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in processing image data associated with crop-bearing fields, the method comprising:
accessing, by a computing device, a first data set, the first data set including images associated with one or more fields, the images having a spatial resolution of about one meter or more per pixel;
generating, by the computing device, based on a generative model, defined resolution images of the one or more fields from the first data set, the defined resolution images each having a spatial resolution of about X centimeters per pixel, where X is less than about 5 centimeters;
deriving, by the computing device, index values for the one or more fields, based on the defined resolution images of the one or more fields;
aggregating, by the computing device, the index values for the one or more fields with at least one environmental metric for the one or more fields;
predicting, by the computing device, a plot yield for the one or more fields, based on the aggregated index values and the at least one environmental metric; and
storing, by the computing device, the predicted yield for the one or more fields in a memory.

2. The computer-implemented method of claim 1, wherein X is less than or equal to about 1 centimeter; and
wherein the first data set includes satellite images of the one or more fields, in which a crop is grown.

3. The computer-implemented method of claim 1, wherein the generative model includes a diffusion model.

4. The computer-implemented method of claim 1, wherein the generative model includes a generative adversarial network (GAN) model, and wherein the GAN model includes a generator and a discriminator coupled to the generator, and
wherein generating the defined resolution images includes generating, by the generator, the defined resolution images based on at least one input image from the first data set.

5. The computer-implemented method of claim 1, further comprising defining, by the computing device, a field level image for each of the one of more fields, from the defined resolution images; and
wherein deriving the index values for the one or more fields includes deriving the index values for each of the field level images for the one or more fields.

6. The computer-implemented method of claim 5, wherein deriving the index values includes deriving each of the index values based on the following:
index value=(nir−red)/(nir+red);
wherein nir is a near infrared band value of each of the field level images and red is a red band value of each of the field level images.

7. The computer-implemented method of claim 1, wherein the index values are representative of a vegetation greenness of the one or more fields.

8. The computer-implemented method of claim 1, wherein the images of the first data set further include a temporal resolution of one image per N number of days, where N is an integer less than about 30; and
wherein the defined resolution images of the one or more fields include said temporal resolution.

9. The computer-implemented method of claim 1, wherein the at least one environmental metric includes at least one of: precipitation, solar radiation, and/or temperature.

10. The computer-implemented method of claim 1, wherein aggregating the index values for the one or more fields with the at least one environmental metric for the one or more fields includes aggregating the index values with the at least one environmental metric, using one of inverted variance weighting and convolutional neural networking, into a combined metric; and
wherein predicting the plot yield is based on the combined metric.

11. The computer-implemented method of claim 1, further comprising:
accessing, by the computing device, a training data set, the training data set include a high resolution data set and a low resolution data set;
wherein the high resolution data set includes images associated with the one or more fields, the images of the high resolution data set having a spatial resolution of about X centimeters per pixel, where X is an integer less than about 5; and
wherein the low resolution data set includes images associated with one or more fields, the images of the low resolution data set having a spatial resolution of at least about one meter per pixel; and
training the generative model, based on at least a portion of the high resolution data set and the low resolution data set.

12. A system for use in processing image data associated with crop-bearing fields, the system comprising:
a computing device configured to:
access a first data set, the first data set including images associated with one or more fields, the images having a spatial resolution of about one meter or more per pixel;
generate, based on a generative model, defined resolution images of the one or more fields from the first data set, the defined resolution images each having a spatial resolution of about X centimeters per pixel, where X is less than about 5 centimeters;
derive index values for the one or more fields, based on the defined resolution images of the one or more fields;
aggregate the index values for the one or more fields with at least one environmental metric for the one or more fields;
predict a plot yield for the one or more fields, based on the aggregated index values and the at least one environmental metric; and
store the predicted yield for the one or more fields in a memory.

13. The system of claim 12, wherein X is less than or equal to about 1 centimeter; and
wherein the first data set includes satellite images of the one or more fields, in which a crop is grown.

14. The system of claim 12, wherein the generative model includes a diffusion model.

15. The system of claim 12, wherein the generative model includes a generative adversarial network (GAN) model, and wherein the GAN model includes a generator and a discriminator coupled to the generator, and
wherein the computing device is configured, in order to generate the defined resolution images, to generate, via the generator, the defined resolution images based on at least one input image from the first data set.

16. The system of claim 12, wherein the index values are representative of a vegetation greenness of the one or more fields;
wherein the images of the first data set further include a temporal resolution of one image per N number of days, where N is an integer less than about 30; and
wherein the defined resolution images of the one or more fields include said temporal resolution.

17. The system of claim 12, wherein the computing device is configured, in order to aggregate the index values for the one or more fields with the at least one environmental metric for the one or more fields, to aggregate the index values with the at least one environmental metric, using one of inverted variance weighting and convolutional neural networking, into a combined metric; and
wherein the computing device is configured, in order to predict the plot yield, to predict the plot yield based on the combined metric.

18. The system of claim 12, wherein the computing device is further configured to:
access a training data set, the training data set include a high resolution data set and a low resolution data set;
wherein the high resolution data set includes images associated with the one or more fields, the images of the high resolution data set having a spatial resolution of about X centimeters per pixel, where X is an integer less than about 5; and
wherein the low resolution data set includes images associated with one or more fields, the images of the low resolution data set having a spatial resolution of at least about one meter per pixel; and
train the generative model, based on at least a portion of the high resolution data set and the low resolution data set.

19. The system of claim 12, wherein the computing device is further configured to aggregate the index values for the one or more fields with at least one environmental metric for the one or more fields.

20. A non-transitory computer-readable storage medium including executable instructions for processing image data, which when executed by at least one processor, cause the at least one processor to:
access a first data set of images having a spatial resolution of about one meter or more per pixel;
generate, based on a generative model, defined resolution images from the first data set of images, the defined resolution images each having a spatial resolution of about X centimeters per pixel, where X is less than about 5 centimeters;
derive index values for a feature of the images included in the first data set of images, based on the corresponding defined resolution images;
aggregate the index values for the feature with at least one metric for the feature;
predict a characteristic for the feature, based on the aggregated index values and the at least one metric; and
store the predicted characteristic for the feature in a memory.
